(19) United States
(12) Patent Application Publication
(10) Pub. No.: US 2012/0009941 A1
(43) Pub. Date: Jan. 12, 2012

(54) Method and apparatus for providing a location based service

(75) Inventors: Lei Zhou, Beijing (CN); Hai Wang, Beijing (CN); Xufeng Zheng, Beijing (CN)

(73) Assignee: Samsung Electronics Co., Ltd., Suwon-si (KR)

(21) Appl. No.: 13/135,474

(22) Filed: Jul. 6, 2011

(30) Foreign Application Priority Data
Jul. 6, 2010 (CN) 201010222536.X
Sep. 7, 2010 (CN) 201010276555.0

(51) Int. Cl. H04W 4/02

(52) U.S. Cl. 455/456.1

(57) ABSTRACT

An application method of a Location Based Service-zone (LBS-zone) is capable of implementing instruction and measurement for the LBS-zone. The method includes sending, by a serving Base Station (BS) located by a Mobile Station (MS), an instruction message indicating an LBS-zone exists, to the MS. The method also includes, when the LBS-zone exists, and the MS measures a reference signal sent by a neighbor BS in the LBS-zone, receiving, by the MS, the reference signal in the LBS-zone, which is sent by the neighbor BS and used for locating the MS, according to the instruction message. The method also includes measuring, by the MS, the reference signal, and sending a measurement result to the serving BS. Using embodiments of the invention, the MS may be enabled to obtain information of the LBS-zone accurately, so as to implement normal measurement for the LBS-zone and measurement result feedback.

### CROSS-REFERENCE TO RELATED APPLICATION(S) AND CLAIM OF PRIORITY

The present application is related to and claims the benefit under 35 U.S.C. §119(a) of a Chinese patent application filed in the Chinese Intellectual Property Office on Jul. 6, 2010 and assigned Application No. 201010222536.X and a Chinese patent application filed in the Chinese Intellectual Property Office on Sep. 7, 2010 and assigned Application No. 201010276555.0, the entire disclosures of which are hereby incorporated by reference.

### TECHNICAL FIELD OF THE INVENTION

The invention relates to a method and apparatus for providing location based service in a communication system.

### BACKGROUND OF THE INVENTION

Wireless location based service (LBS) technologies have found wide applications, with the development from initial Automatic Vehicle Location (AVL), to subsequent public transport, taxi scheduling and police tracking, and so forth. With the increasing demand for location based information service, the wireless LBS technology becomes an important technology in mobile communication systems.

To improve accuracy of LBS service for a mobile station (MS) implemented by a serving base station (BS) in a mobile communication system, the concept of a LBS-zone has been introduced in the IEEE 802.16m standard. The standard stipulates that a whole LBS-zone consists of four (4) Orthogonal Frequency Division Multiplexing (OFDM) symbols.

FIG. 1 is a schematic diagram illustrating a structure of a system frame in the existing IEEE 802.16m standard. Each of the four (4) OFDM symbols respectively comes from four (4) successive superframes, which may refer to the schematic diagram illustrating structure of a system frame shown in FIG. 1.

As shown in FIG. 1, the system frame consists of several superframes respectively with a superframe header. Each superframe includes four (4) frames respectively with a preamble, and the length of each frame is 5 ms. The preamble of the second frame is a main preamble. Preambles of the other three frames are auxiliary frames. The superframe header is behind the auxiliary preamble of the first frame. Each frame consists of eight (8) subframes. The first five (5) subframes demonstrate downlink. The last three (3) subframes demonstrate uplink. Each subframe consists of six (6) OFDM symbols. When one OFDM symbol of the LBS-zone exists in a certain superframe, the OFDM symbol is the first OFDM symbol located in the first subframe of the last frame in the superframe. When there is no OFDM symbol of the LBS-zone in a certain superframe, the first OFDM symbol in the first subframe of the last frame in the superframe may be taken as a synchronization symbol, or a data symbol, which may be determined in practical applications.

However, current IEEE 802.16m only provides the concept of the LBS-zone, instead of providing specific application schemes of the LBS-zone. Without an application scheme, the MS cannot obtain information of the LBS-zone accurately, and subsequently the MS cannot implement normal measurement for the LBS-zone and accurate measurement result feedback. That is, the LBS-zone cannot work normally. Thus, the objective of implementing the LBS service for the MS by a serving BS with the LBS-zone cannot be achieved.

### SUMMARY OF THE INVENTION

To address the above-discussed deficiencies of the prior art, it is a primary object to provide a method and apparatus for providing LBS.

An aspect of the present invention includes a method and apparatus for obtaining accurate information of LBS-zone.

In accordance with an aspect of the present invention, a method for providing a Location Based Service (LBS) by a serving Base Station (BS) is provided. The method includes sending an instruction message indicating that an LBS-zone that provides LBS exists to a Mobile Station (MS). The method also includes receiving a measurement result for a reference signal sent by a neighbor BS located in the LBS-zone from the MS. The measurement result is measured by using information of the LBS-zone included in the instruction message.

In accordance with another aspect of the present invention, a method for receiving a Location Based Service (LBS) by a Mobile Station (MS) is provided. The method includes receiving an instruction message indicating that an LBS-zone that provides LBS exists to the serving Base Station (BS). The method also includes obtaining information of the LBS-zone from the instruction message. The method further includes receiving a reference signal from a neighbor BS located in the LBS-zone. The method also includes measuring the reference signal, and transmitting a measurement result to the serving BS.

In accordance with another aspect of the present invention, a serving Base Station (BS) for providing a Location Based Service (LBS) is provided. The BS includes a transmitter configured to send an instruction message indicating that an LBS-zone that provides LBS exists to a Mobile Station (MS). The BS also includes a receiver configured to receive a measurement result for a reference signal sent by a neighbor BS located in the LBS-zone from the MS. The measurement result is measured by using information of the LBS-zone included in the instruction message.

In accordance with another aspect of the present invention, a Mobile Station (MS) for receiving a Location Based Service (LBS) is provided. The MS includes a receiver configured to receive an instruction message indicating that an LBS-zone that provides LBS exists to the serving Base Station (BS), and receive a reference signal from a neighbor BS located in the LBS-zone. The MS also includes a controller configured to obtain information of the LBS-zone from the instruction message, and measure the reference signal. The MS further includes a transmitter configured to transmit a measurement result to the serving BS.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic diagram illustrating a structure of a system frame in the existing IEEE 802.16m standard.

FIG. 2 is a work flowchart illustrating an application method of a LBS-zone in accordance with a first embodiment of the invention.

FIG. 3 is a schematic diagram illustrating parameters of scan duration about an LBS-zone.

FIG. 4 is a design schematic diagram illustrating a start point of an LBS-zone in accordance with an embodiment of the invention.

FIG. 5 is a work flowchart illustrating an application method of an LBS-zone in accordance with a second embodiment of the invention.

FIG. 6 is a work flowchart illustrating an application method of the LBS-zone in accordance with a third embodiment of the invention.

FIG. 7 is a schematic diagram illustrating a principle of sending a superframe header periodically to a mobile station (MS) by a serving base station (BS).

FIG. 8 is a schematic diagram illustrating processes of putting an instruction message of two bits into subpacket 1 (SP1), and sending SP1 periodically in accordance with an embodiment of the invention.

FIG. 9 is a schematic diagram illustrating a principle of sending with the mode shown in FIG. 6.

FIG. 10 is a block diagram illustrating a structure of a serving BS in accordance with embodiments of the invention.

FIG. 11 is a block diagram illustrating a structure of a MS in accordance with embodiments of the invention.

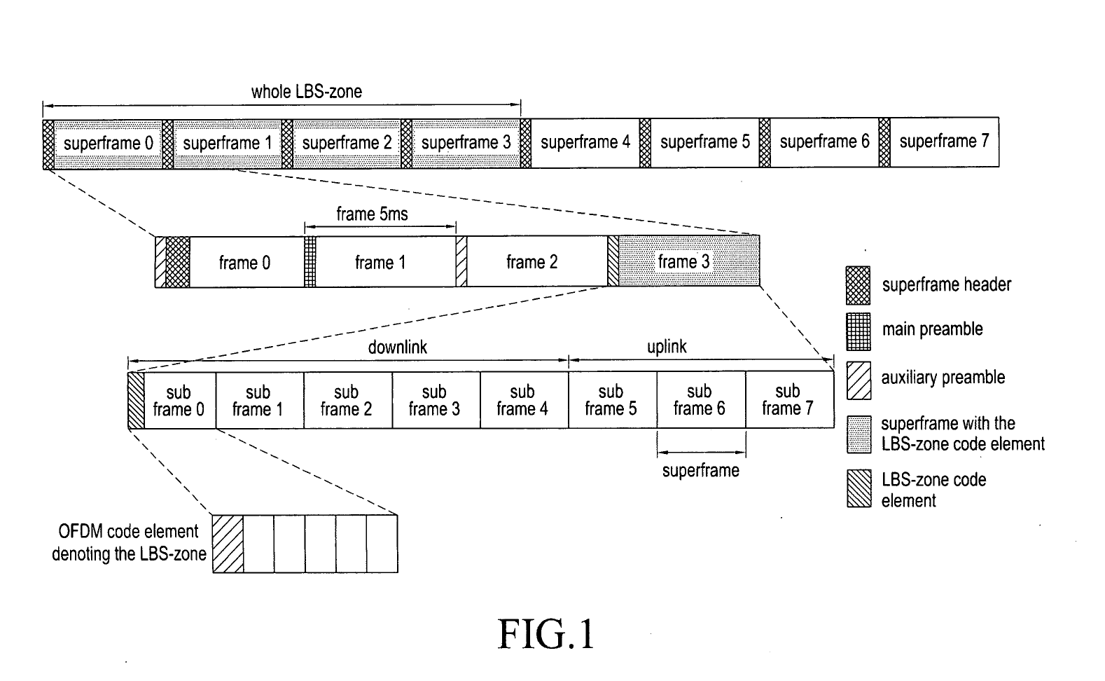

### DETAILED DESCRIPTION OF THE INVENTION

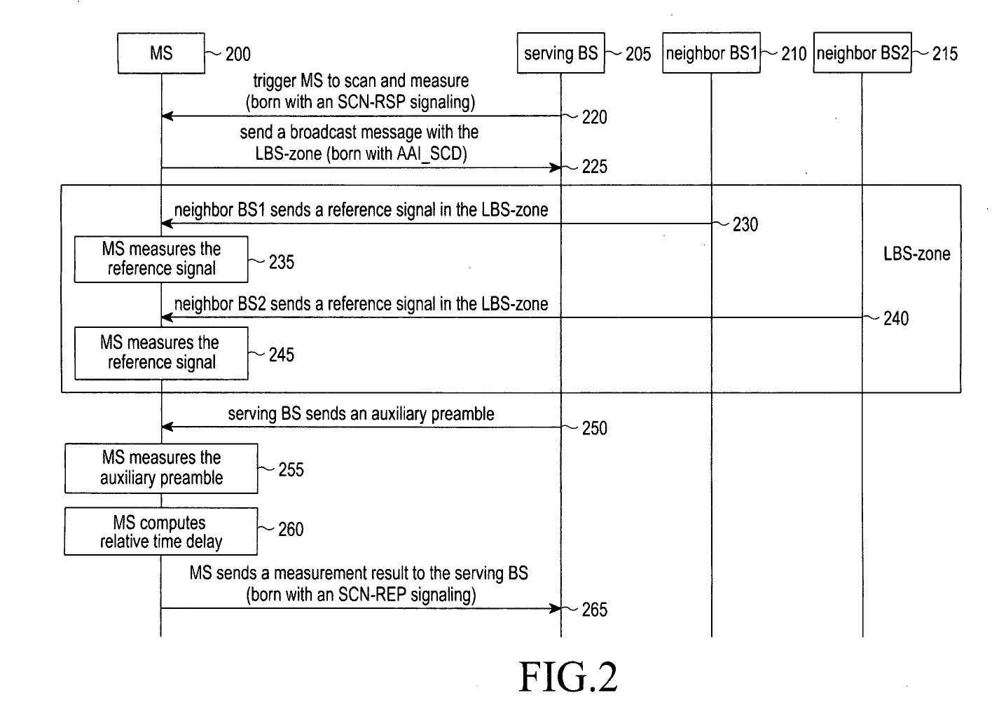

FIGS. 2 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system. The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent be enabled to be applied. Subsequently, the objective of implementing the LBS service for the MS by the serving BS with the LBS-zone may be achieved.

Before introduction about a specific implementation scheme is given, it should be noted that, to implement the LBS service for the MS by the serving BS with the LBS-zone, the MS learns whether the LBS-zone exists. When the LBS-zone exists, and the MS measures a reference signal sent by a neighbor BS in the LBS-zone, the MS receives and measures a reference signal, which is sent by a neighbor BS and used for locating the MS, so as to implement the LBS service for the MS.

Based on above introduction, the specific implementation of scheme provided by embodiments of the invention is as follows.

The serving BS, where the MS is located, sends an instruction message indicating an LBS-zone exists, to the MS. The MS receives a reference signal in the LBS-zone, which is sent by a neighbor BS and used for locating the MS, according to the instruction message. The MS measures the reference signal, and sends a measurement result to the serving BS.

In the embodiments of the invention, an instruction message indicating that an LBS-zone exists may be implemented with three modes including a first mode to a third mode. The instruction message includes information of a LBS-zone, the information of LBS-zone specifically describes following. Specifically, in the first mode, the serving BS sends a broadcast message as the instruction message to the MS. In the second mode, an instruction message is added in a superframe header. In the third mode, a combination of the first mode and the second mode, the serving BS broadcasts to the MS an instruction message that is added in a superframe header.

To make objectives, technical solution and advantages of the invention more clear, detailed descriptions about the invention will be given in the following accompanying with attached figures and specific embodiments.

### A First Embodiment

In the first embodiment, a serving BS sends a broadcast message including the information of the LBS-zone to an MS. After the MS receives the broadcast message, the MS obtains location, period or duration of the LBS-zone from the information of the LBS-zone. Furthermore, the MS measures a reference signal sent by each neighbor BS in the LBS-zone, and sends a measurement result to the serving BS, the specific implementation flow of which may refer to FIG. 2. As shown in FIG. 2, the flow includes the following blocks.

FIG. 2 is a work flowchart illustrating an application method of a LBS-zone in accordance with a first embodiment of the invention. In block 220, the serving BS 205 sends a SCN-RSP (Scan-Response) signaling to the MS 200, to trigger the MS 200 to scan a reference signal sent by a neighbor BS located in the LBS-zone. Other signaling may also be adopted to perform the triggering in practical applications, which may be determined by implementation of embodiments in the invention.

It should be noted that, in the block 220, the SCN-RSP signaling includes the information of the LBS-zone; the specific format for the information of the LBS-zone may refer to Table 1 below. That is, the information of the LBS-zone may include the following six (6) instruction units, instruction for scanning the LBS-zone, duration for scanning the LBS-zone, scan report mode, report parameters, report period and start superframe number of scan.

TABLE 1

| signaling | size | |
|---|---|---|
| content | (bit) | content description |
| instruction for | 1 | 0b0: not support the scan |
| scanning the | | 0b1: support the scan |
| LBS-zone | | |
| duration for | 6 | take 4 superframes (a whole LBS-zone) as |
| scanning the | | a time unit |
| LBS-zone | | |
| scan report | 1 | 0b0: one scan |
| mode | | 0b1: scan periodically |
| report | 3 | instruct to report parameter with bitmap |
| parameter | | mode includes: |
| | | Bit 0: Carrier-to-Interference-and-Noise Ratio |
| | | (CINR) mean |
| | | Bit 1: Received Signal Strength Indication |
| | | (RSSI) mean |
| | | Bit 2: relative time delay |
| report period | 6 | take 4 superframes (a whole LBS-zone) as a |
| | | time unit, meanwhile a start point may be |
| | | directly informed by an SCN-RSP, or starting |
| | | from a start superframe of the scanned |
| | | LBS-zone stipulated in advance |
| starting | 6 | a start superframe of the scan may be identified |
| superframe | | with the most meaningful 6 bits of the |
| number of | | superframe number |
| scan | | |

The report parameters include relative time delay, Carrier-to-Interference-and-Noise-Ratio (CINR) mean and Received Signal Strength Indication (RSSI) mean. When the scan is started from a fixed location, or the scan is stipulated to start from an LBS-zone which is closest to the SCN-RSP, the start superframe number of the scan may be omitted, and may be obtained by computing with the following Equation 1.

Nₛₜₐᵣₜₚₒᵢₙₜ=N_{AAI}_{_{—}}_{SCD}+4×N_{offset}−mod(N_{AAI}_{_{—}}_{SCD},4). [Eqn. 1]

Here, Nₛₜₐᵣₜₚₒᵢₙₜ denotes a superframe number, where a start point of the LBS-zone is located. N_{AAI}_{_{—}}_{SCD} denotes a superframe index, where an advanced air interface system configuration descriptor (AAI-SCD) signaling is located. N_{offset} refers to a large offset between the start point of the LBS-zone and the superframe index, where the AAI-SCD signaling is located. The N_{offset} may be obtained by modulo 4, to the difference between the start point of the LBS-zone and the AAI-SCD signaling. Here, mod(N_{AAI}_{_{—}}_{SCD},4) refers to getting the remainder after dividing N_{AAI}_{_{—}}_{SCD} by 4.

When the N_{offset} is determined, e.g., N_{offset}=1, the start point of the scan may be obtained by computing with the Equation 2.

Nₛₜₐᵣₜₚₒᵢₙₜ=N_{AAI}_{_{—}}_{SCD}+4−mod(N_{AAI}_{_{—}}_{SCD},4) [Eqn. 2]

It should be noted that, the number 4 in Equation 2 above refers to the superframe number occupied by a whole LBS-zone. When the superframe number occupied by a whole LBS-zone is another number, the number 4 in above formula should be that other number.

When the LBS-zone information carried in a sub-packet (SPx) of a superframe header is a period of the LBS-zone, or both the period and duration of the LBS-zone, the start point of the LBS-zone may be obtained by computing with the following Equation 3.

Nₛₜₐᵣₜₚₒᵢₙₜ=mod((N_{S-SFH(SPx)}+Q−mod(N_{S-SFH(SPx)},Q)),2ⁿ) [Eqn. 3]

Here, Nₛₜₐᵣₜₚₒᵢₙₜ denotes a superframe number, where the start point of the LBS-zone is located. N_{S-SFN(SPx)} denotes a superframe header SPx including parameter or configuration information (period, duration, and the like) of a first (an initial) LBS-zone, or denotes a superframe index, where the superframe header SPx is located, in which the SPx includes the parameter or configuration change information (e.g., when the period is changed) of the LBS-zone. Q denotes the period of emergence about the LBS-zone (superframe number is taken as a unit). Mod(N_{S-SFN(SPx)}),Q) refers to getting the remainder after dividing N_{S-SFN(SPx)} by Q. And n denotes the bit length adopted by the superframe index.

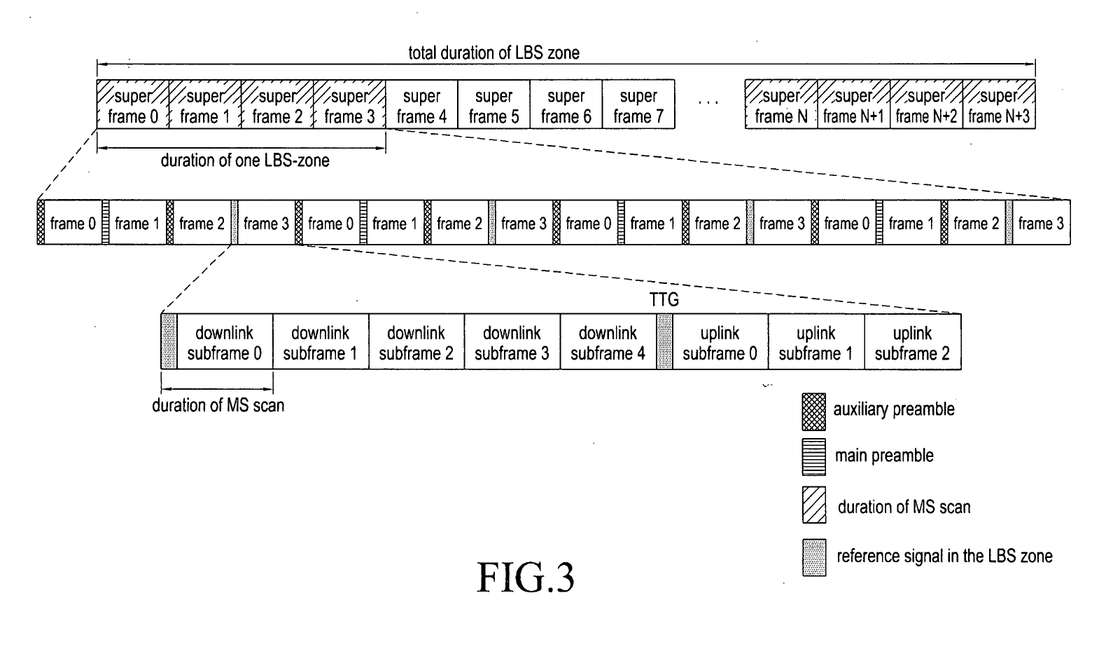

To describe the duration for scanning the LBS-zone in Table 1 more clear, FIG. 3 provides a diagram for illustrating parameters of scan duration of the LBS-zone.

As shown in FIG. 3, there are two main scan durations. The first one is total duration for scanning the LBS-zone by the MS, which mainly stipulates that the MS scans an emerged LBS-zone within this time period (the LBS-zone emerges periodically or only once). The second scan duration refers to the actual time used for scanning by the MS. To scan a reference signal in one LBS-zone, the scan duration of the MS may be configured to one symbol or at least one subframe (including a subframe of the reference signal, or including a subframe of the reference signal as well as several adjacent subframes).

It should be noted that, to obtain signal arrival time between the serving BS 205 and the MS 200, the MS 200 scans the auxiliary preamble of the serving BS.

After executing operations in the block, the MS 200 waits for block 225, and scans the reference signal sent by a neighbor BS in the LBS-zone, until receiving the broadcast signaling sent by the serving BS 205.

In the block 225, the MS 200 receives the broadcast message, which is sent by the serving BS 205 and carries the LBS-zone information, so as to learn the specific location of the LBS-zone.

In the block 225, the broadcast message is sent to the MS 200 by a system configuration description (AAI_SCD) signaling. In practical applications, other signaling may also be adopted to send the broadcast message.

It should be noted that the LBS-zone information carried in the broadcast message may include the start point, period and duration of the LBS-zone, or may include only the period and duration of the LBS-zone. When the LBS-zone information only includes the period and duration of the LBS-zone, the MS 200 may compute the start point of the LBS-zone, according to received LBS-zone information. Alternatively, the information of the LBS-zone carried in the broadcast message may only include the period of the LBS-zone. Thus, the MS 200 may compute the start point of the LBS-zone according to received LBS-zone information, and may obtain duration of the LBS-zone according to the start point, and end point information which is included in the broadcast message. The start point of the LBS-zone, which is referred to with respect to a superframe where the broadcast message is located, is used for identifying the start location of the LBS-zone. The period of the LBS-zone refers to the time interval of emergence of the LBS-zone, that is, the LBS-zone is sent periodically. The duration of the LBS-zone refers to the time length of LBS-zone emergence within a time period. After learning the period and duration of the LBS-zone, the MS 200 may scan when the LBS-zone is emerged. Thus, scan loss may be saved. When the start point of the LBS-zone is included in the information of the LBS-zone, the specific content of the broadcast message may refer to Table 2. When the start point of the LBS-zone is not included in the information of the LBS-zone, the specific content of the broadcast message may refer to Table 3.

TABLE 2

| signaling | size | |
|---|---|---|
| content | (bit) | content description |
| superframe | 6 | offset with respect to a superframe where |
| offset of | | AAI_SCD is located, |
| the start | | which is used for determining |
| point of the | | location of start point of the LBS-zone |
| LBS-zone | | |
| period of the | 2 or 3 | duration of 4 superframes is taken |
| LBS-zone | | as unit of period of the LBS-zone: |
| | | 0b000 [symbol] one LBS-zone is emerged at 80 ms, time |
| | | interval of two LBS-zone is 0; |
| | | 0b001 [symbol] one LBS-zone is emerged at 160 ms, time |
| | | interval of two LBS-zone is 80 ms; |
| | | 0b010 [symbol] one LBS-zone is emerged at 320 ms, |
| | | time interval of two LBS-zone is 240 ms; |
| | | 0b011 [symbol] one LBS-zone is emerged at 640 ms, time |
| | | interval of two LBS-zone is 560 ms; |
| | | 0b100 [symbol] one LBS-zone is emerged at 1280 ms, time |
| | | interval of two LBS-zone is 1200 ms; |
| | | 0b101 [symbol] one LBS-zone is emerged at 2560 ms, |
| | | time interval of two LBS-zone is 2480 ms; |
| | | 0b110 [symbol] one LBS-zone is emerged at 5120 ms, |
| | | time interval of two LBS-zone is 5040 ms; |
| | | 0b111 [symbol] reserved. |
| duration of | 8 | the LBS-zone is emerged within a stipulated |
| the LBS- | | time period, which may be 5120 as a |
| zone | | largest number |

TABLE 3

| signaling | size | |
|---|---|---|
| content | (bit) | content description |
| integral | 3 | to determine large offset of the start point, computed |
| multiple | | with the following formula |
| offset of the | | Nₛₜₐᵣₜₚₒᵢₙₜ = N_{AAI}_SCD + 4 − mod (N_{AAI}_SCD, 4) |
| start point | | |
| of the | | |
| LBS-zone | | |
| (offsetting | | |
| with the | | |
| multiple | | |
| of 4) | | |
| period of the | 2 or 3 | duration of 4 superframes is taken as unit of |
| LBS-zone | | period of the LBS-zone: |
| | | 0b000 [symbol] one LBS-zone is emerged at 80 ms, |
| | | time interval of two LBS-zone is 0; |
| | | 0b001 [symbol] one LBS-zone is emerged at 160 ms, time |
| | | interval of two LBS-zone is 80 ms; |
| | | 0b010 [symbol] one LBS-zone is emerged at 320 ms, time |
| | | interval of two LBS-zone is 240 ms; |
| | | 0b011 [symbol] one LBS-zone is emerged at 640 ms, time |
| | | interval of two LBS-zone is 560 ms; |
| | | 0b100 [symbol] one LBS-zone is emerged at 1280 ms, time |
| | | interval of two LBS-zone is 1200 ms; |
| | | 0b101 [symbol] one LBS-zone is emerged at 2560 ms, time |
| | | interval of two LBS-zone is 2480 ms; |
| | | 0b110 [symbol] one LBS-zone is emerged at 5120 ms, time |
| | | interval of two LBS-zone is 5040 ms; |
| | | 0b111 [symbol] reserved. |
| duration | 8 | the LBS-zone is emerged within a stipulated |
| of the | | time period, which may be 5120 as a largest number |
| LBS-zone | | |

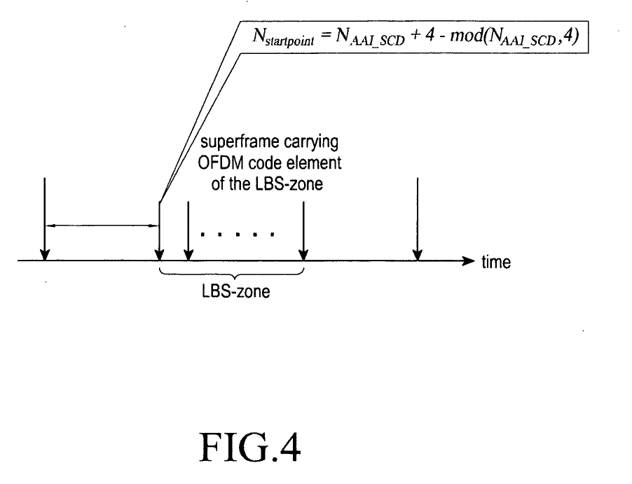

It should be noted that, when the start point of the LBS-zone is not included in the information of the LBS-zone, the computing mode shown in FIG. 4 may be adopted by start point of the LBS-zone.

FIG. 4 is a design schematic diagram illustrating a start point of a LBS-zone in accordance with an embodiment of the invention.

As shown in FIG. 4, when the MS receives a superframe indicating that the LBS-zone exists, the start point of the LBS-zone may be computed with the following Equation 4 according to the superframe number.

Nₛₜₐᵣₜₚₒᵢₙₜ=N_{AAI}_{_{—}}_{SCD}+4×N_{offset}−mod(N_{AAI}_{_{—}}_{SCD},4) [Eqn. 4]

Nₛₜₐᵣₜₚₒᵢₙₜ denotes a superframe number, where the start point of the LBS-zone is located. N_{AAI}_{_{—}}_{SCD} denotes a superframe index, where the AAI_{_{—}}_{SCD} signaling is located. N_{offset} refers to a large offset between the start point of the LBS-zone and a superframe index where the AAI_{_{—}}_{SCD} signaling is located. The N_{offset} may be obtained by modulo 4, to the difference between the start point of the LBS-zone and the AAI_{_{—}}_{SCD} signaling, and mod(N_{AAI}_{_{—}}_{SCD},4) refers to getting the remainder after dividing N_{AAI}_{_{—}}_{SCD} by 4.

Or, when the N_{offset} is determined, e.g., N_{offset}=1, the start point of the scan may be obtained by computing with the Equation 5.

Nₛₜₐᵣₜₚₒᵢₙₜ=N_{AAI}_{_{—}}_{SCD}+4−mod(N_{AAI}_{_{—}}_{SCD},4) [Eqn. 5]

Similarly, the number 4 in Equation 5 also refers to the superframe number occupied by a whole LBS-zone. When the superframe number occupied by a whole LBS-zone is another number, the number 4 in above formula should be the other number.

It should be noted that, when a remainder 0 is obtained by modulo 4 to the superframe where the AAI_SCD signaling is located, it at least takes the next superframe, remainder of which is 0 after modulo 4, as a superframe where the start point of the LBS-zone is located.

Or, when the information of the LBS-zone carried in a sub-packet (SPx) of a superframe header includes a period of the LBS-zone, or period and duration of the LBS-zone, the start point of the LBS-zone may be obtained by computing with the following Equation 6.

Nₛₜₐᵣₜₚₒᵢₙₜ=mod((N_{S-SFH(SPx)}+Q−mod(N_{S-SFH(SPx)},Q)),2ⁿ) [Eqn. 6]

Nₛₜₐᵣₜₚₒᵢₙₜ denotes a superframe number, where the start point of the LBS-zone is located. N_{S-SFN(SPx)} denotes a superframe header SPx, which includes parameter or configuration information (period, duration, and the like) of a first (an initial) LBS-zone, or denotes a superframe index, where the superframe header SPx is located, in which the SPx includes parameter or configuration change information (e.g., when the period is changed) of the LBS-zone. Q denotes the period of the emergence of the LBS-zone (superframe number as a unit). Mod(N_{S-SFN(SPx)},Q) refers to getting the remainder after dividing N_{S-SFN(SPx)} by Q, and n denotes the bit length used by the superframe index.

When the superframe number located by the start point of the LBS-zone is obtained by computing, the start point of the LBS-zone may be obtained according to the obtained superframe number.

In block 230, each of neighbor BS1 210, BS2 215 sends a reference signal included in OFDM symbol occupied by the LBS-zone in the superframe. The reference signal is sent by using a Code Division Multiple Access (CDMA) scheme or orthogonal sequence, and the like.

In block 235, the MS 200 respectively scans and measures the reference signal sent by each of the neighbor BS1 210, BS2 215, to obtain signal arrival time, CINR mean and RSSI mean of each of the neighbors BS1 210, BS2 215. In the block 235, the processes of the MS 200 scanning and measuring the reference signal, to obtain signal arrival time of each neighbor BS1 210, BS2 215, belong to prior art, which are not repeated here.

It should be noted that the process of measuring the reference signal by the MS may be as follows. The MS performs the measurement when the serving BS requests the MS to measure, or the MS actively measures the reference signal sent by each neighbor BS.

In a block 250, the serving BS 205 sends an auxiliary preamble to the MS 200.

In a block 255, the MS 200 measures the auxiliary preamble sent by the serving BS 205, to obtain signal arrival time, CINR mean and RSSI mean of the serving BS 205.

In a block 260, the MS 200 computes the difference between the signal arrival time of the serving BS and the signal arrival time of each neighbor BS, to obtain the relative time delay between signal arrival time of the serving BS and signal arrival time of each neighbor BS1 210, BS2 215.

If the signal arrival time of neighbor BS1 210, neighbor BS2 215, the serving BS 205 is respectively t1, t2 and t, the relative time delay Δt1 and Δt2 obtained are respectively as follows in Equation 7.

Δt1=t−t1; Δt2=t−t2 [Eqn. 7]

In block 208, the MS 200 sends the relative time delay, CINR mean and RSSI mean, which are obtained after computing, to the serving BS 205.

The serving BS 205 obtains the relative time delay, CINR mean and RSSI mean. Thus, the serving BS 205 may select a neighbor BS with better signal quality among the neighbor BS1 210 and neighbor BS2 215, and take the selected neighbor BS as a standby BS for providing the LBS service for the MS 200, according to above results obtained.

In the block 265, the results obtained after computing and measurement, are sent to the serving BS 205 by the MS 200 with a scan report (SCN-REP) signaling. The specific content in the SCN-REP signaling may refer to Table 4.

TABLE 4

| | size | |
|---|---|---|
| signaling content | (bit) | content description |
| report mode | 1 | 0b0: one scan report |
| | | 0b1: report periodically, according to scan |
| | | report period in the SCN-RSP |
| number of | 6 | number of neighbor BS reported should be |
| neighbor | | included in the NBR-ADV information |
| BS reported | | (neighbor BS broadcast signaling) |
| index of | 8 × N | identifier of neighbor BS [symbol] corresponding |
| neighbor BS | | to location of the NBR-ADV information |
| | | (neighbor BS broadcast signaling) |
| CINR mean | 8 | unit measured by the MS with the reference |
| | | signal is 0.5 decibel (dB) |
| RSSI mean | 8 | obtained after MS measuring reference signal |
| | | in LBS-zone, unit of which is 0.25 dB |
| relative time delay | 8 | difference between signal arrival time of |
| | | neighbor BS and that of serving BS, take |
| | | sampling point as unit |

It should be noted that, in the block 265, the MS 200 may send the results, obtained after computing and measurement, to the serving BS 205 with other signaling, which may be determined by implementation of embodiments in the invention.

At this point, the whole work flow for applying the LBS-zone adopted by embodiments of the invention is finished.

It should be noted that, in the embodiment, the MS 200 may measure the reference signal sent by a neighbor BS only once, or may measure and report the reference signal sent by a neighbor BS periodically, which may be determined by practical requirements.

### A Second Embodiment

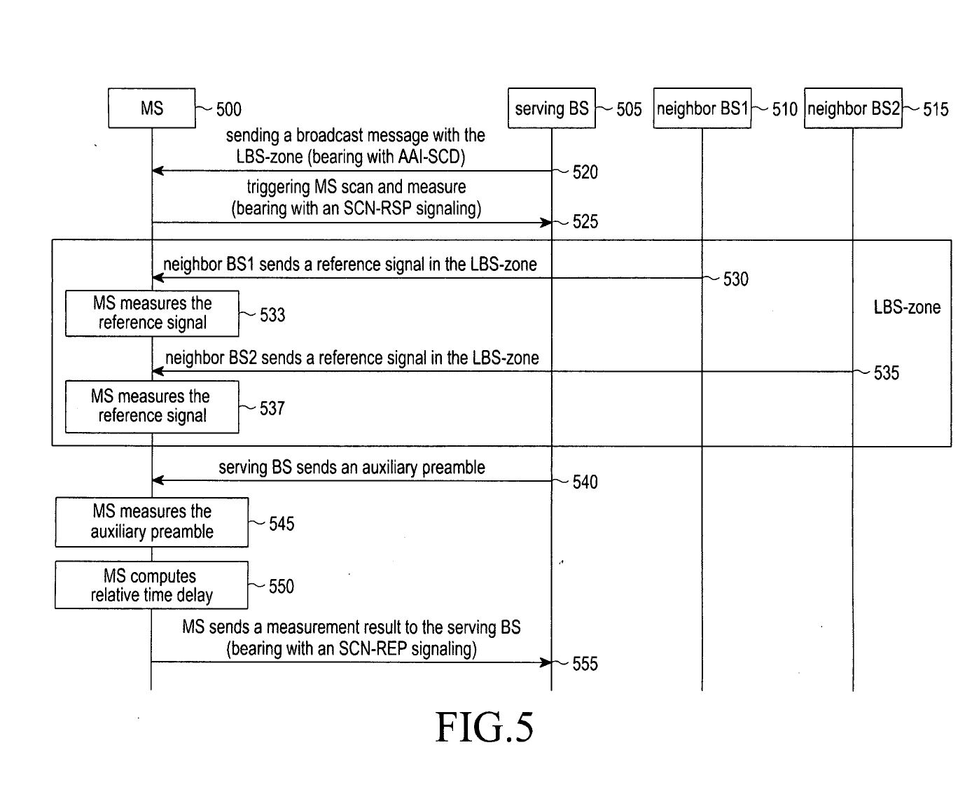

Similar with the first embodiment, in the second embodiment, a broadcast signaling is sent by a serving BS to an MS. The difference with the first embodiment is as follows. In the second embodiment, the MS first receives a broadcast signaling sent by the serving BS with AAI_SCD signaling. After receiving the SCN-RSP signaling, the MS may scan and measure the reference signal sent by each neighbor BS in the LBS-zone, according to the information of the LBS-zone information in the broadcast signaling; the specific flow may refer to FIG. 5.

FIG. 5 is a work flowchart illustrating an application method of LBS-zone in accordance with a second embodiment of the invention.

As shown in FIG. 5, the flow includes the following blocks.

In block 520, a MS 500 receives a broadcast message carrying the information of the LBS-zone sent by the serving BS 505.

In the block 520, the broadcast message is sent to the MS 500 with a system configuration description (AAI_SCD) signaling. In practice, other signaling may also be adopted to send the broadcast message, which may be determined by implementation of embodiments in the invention.

The specific content of broadcast signaling adopted in the block may refer to Tables 2 and 3. The specific processing procedure is similar to block 225, which will not be repeated here.

Block 525: the serving BS 505 sends a scan response (SCN-RSP) signaling to the MS 500, to trigger the MS 500 to scan the reference signal sent by the neighbor BS in the LBS-zone.

In the block 525, the specific format of the SCN-RSP signaling may also refer to Table 1, which will not be repeated here.

Similarly, in the block 525, the MS 500 also scans the auxiliary preamble of the serving BS 505.

In blocks 530 to 555, the specific operations are the same as, or similar to, blocks 230 to 265, and a detailed description will not be repeated here.

Until now, the whole work flow for applying the LBS-zone adopted by the second embodiment is finished.

It should be noted that, similar with the first embodiment, the MS may measure the reference signal sent by the neighbor BS only once in the embodiment, or may measure and report the reference signal sent by the neighbor BS periodically, which may be determined by practical requirements.

It also should be noted that, in the second embodiment, after receiving the SCN-RSP signaling, the basic principle for the MS to start to scan measured reference signal is as follows. Scanning starts from the first OFDM symbol in the next LBS-zone of a superframe, where the SCN-RSP signaling is located. That is, no matter whether the first OFDM symbol of the LBS-zone exists in the superframe, where the SCN-RSP signaling is located, it scans from the first OFDM symbol of the next LBS-zone.

### A Third Embodiment

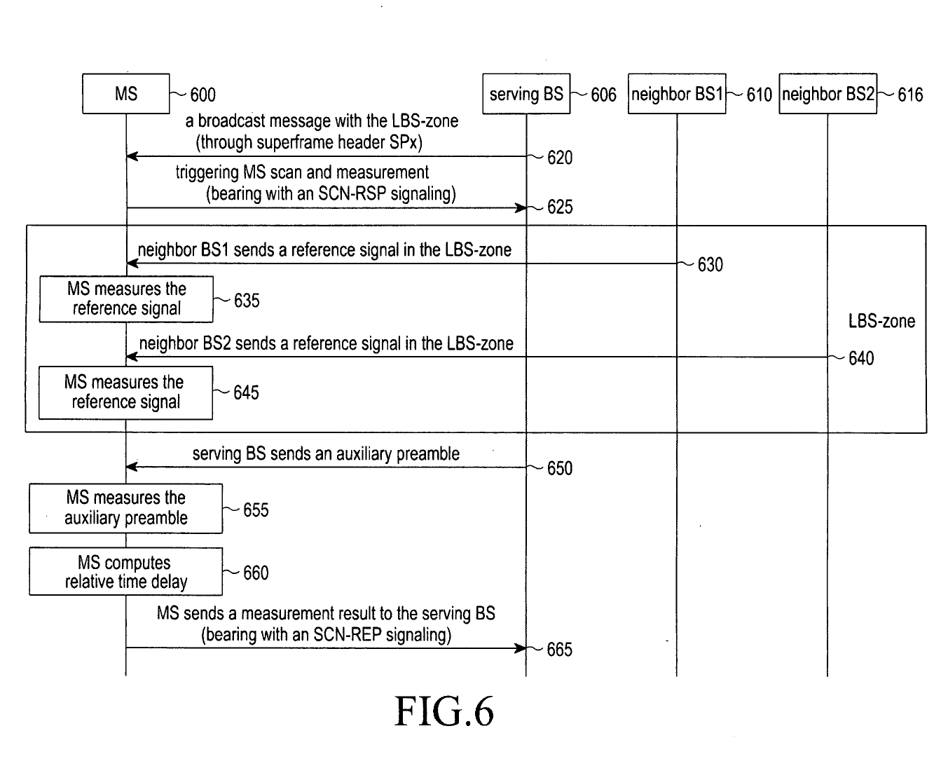

Similar to the first and second embodiments, in the third embodiment, the broadcast message is also sent to the MS by the serving BS. Similar to the second embodiment, the MS also first receives the broadcast message sent by the serving BS in the embodiment. A difference of the third embodiment is as follows. In the third embodiment, the broadcast message is sent out by being carried in a superframe header. The specific work flow may refer to FIG. 6.

FIG. 6 is a work flowchart illustrating an application method of the LBS-zone in accordance with a third embodiment of the invention.

As shown in FIG. 6, the specific operations of blocks 630-665 are same as, or similar to, blocks 230-265, and a detailed description will not be repeated here.

### A Fourth Embodiment

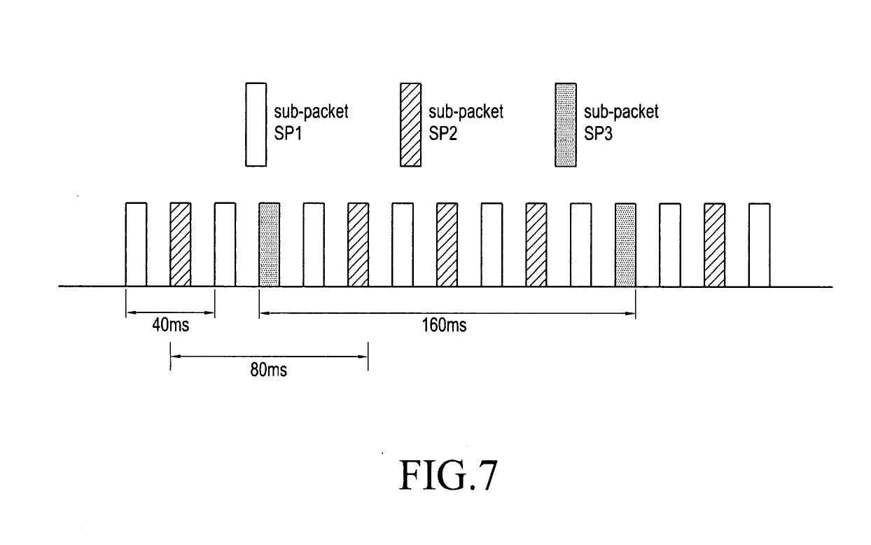

Different from the first, second and third embodiments, the fourth embodiment is implemented by adding an instruction message to a superframe header. There are two types of superframe headers. The first kind is a primary superframe header. The other one is an auxiliary superframe header. The primary superframe header is configured to indicate the period of the auxiliary superframe header. Based on different periods, the auxiliary superframe header may be divided into three kinds of sub-packets, e.g., SP1, SP2 and SP3 respectively, which may refer to FIG. 7.

FIG. 7 is a schematic diagram illustrating a principle of sending a superframe header periodically to a Mobile Station (MS) by a serving Base Station (BS).

As shown in FIG. 7, the periods of SP1, SP2 are respectively 40 ms and 80 ms. The period of SP3 is 160 ms or 320 ms.

In the fourth embodiment, the instruction message may adopt one bit, two bits or multiple bits. The instruction message may be located in SP1, SP2 or SP3. The specific implementation procedure will be respectively given in the following.

When the instruction message is located in SP1, the specific content thereof may refer to Table 5 below, which will be described in detail in the following.

When one bit is taken as the length of an instruction message, it denotes whether the current superframe and the next superframe after the current superframe include OFDM symbol of the LBS-zone. Thus, a whole LBS-zone may be formed by at least two SP1 instructions. The MS may demodulate the first SP1 at first, and then to demodulate the primary superframe header, to check whether the SP1 changes. If there is no change, the bit denoting SP1 instructs no change. That is, the following two superframes still include the OFDM symbol of the LBS-zone.

TABLE 5

| digit | |
|---|---|
| (bit) | description of instruction message |
| 1 | 0b0: denote current superframe and next superframe |
| | not include OFDM code element of LBS-zone; |
| | 0b1: denote current superframe and next superframe |
| | include OFDM code element of LBS-zone. |
| 2 | 0b00: denote current superframe and next 3 superframes not |
| | include OFDM code element of LBS-zone; |
| | 0b01: denote current superframe n and next superframe n + 1 |
| | not include OFDM code element of LBS-zone, |
| | but next two superframes (n + 2 and n + 3) |
| | subsequent to superframe n + 1 include OFDM code element |
| | of LBS-zone; |
| | 0b10: denote current superframe n and next superframe |
| | n + 1 include OFDM code element of LBS-zone, but next |
| | two superframes (n + 2 and n + 3) subsequent to |
| | superframe n + 1 not include OFDM code element of LBS-zone; |
| | 0b11: denote current superframe n and next superframe n + 1 |
| | include OFDM code element of LBS-zone, but next two |
| | superframes (n + 2 and n + 3) subsequent to superframe |
| | n + 1 include OFDM code element of LBS-zone. |

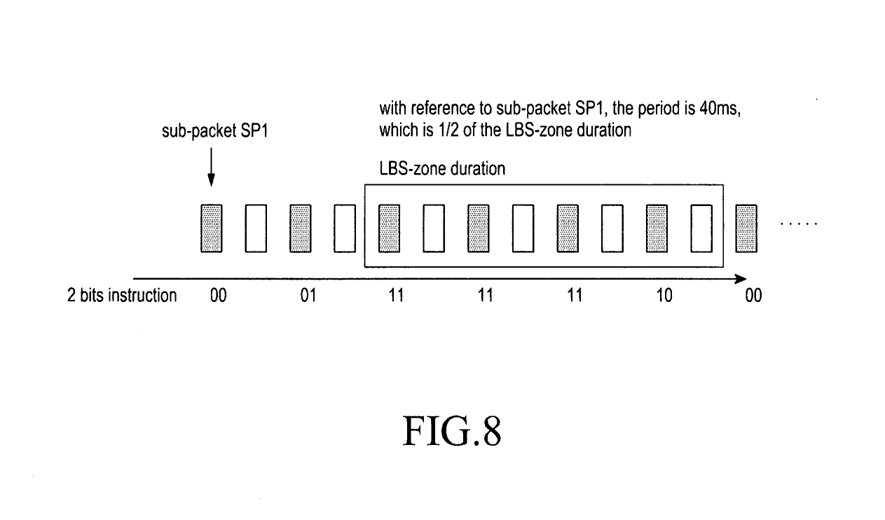

When two bits are taken as the length of an instruction message, the two bits are configured to denote whether the current superframe and the next three (3) superframes include OFDM symbol of the LBS-zone. The specific implementation flow may refer to FIG. 8.

FIG. 8 is a schematic diagram illustrating processes of putting an instruction message of two bits into SP1, and sending SP1 periodically in accordance with an embodiment of the invention.

As shown in FIG. 8, two bits in SP1 are adopted to indicate the LBS-zone. A duration of the LBS-zone is one half (½) of the period of the SP1. The first bit denotes whether the current superframe of SP1 and the next superframe include OFDM symbol of the LBS-zone. The second bit denotes whether the superframe located by the next SP1, and subsequent superframe include OFDM symbol of the LBS-zone. For example, when the instruction is 11, it may be determined that the successive SP1 and next 3 successive superframes possess OFDM symbol of the LBS-zone. The MS may perform a whole scan, which doesn't need to scan from the start point of the LBS-zone. Thus, reduced measurement time delay may be obtained.

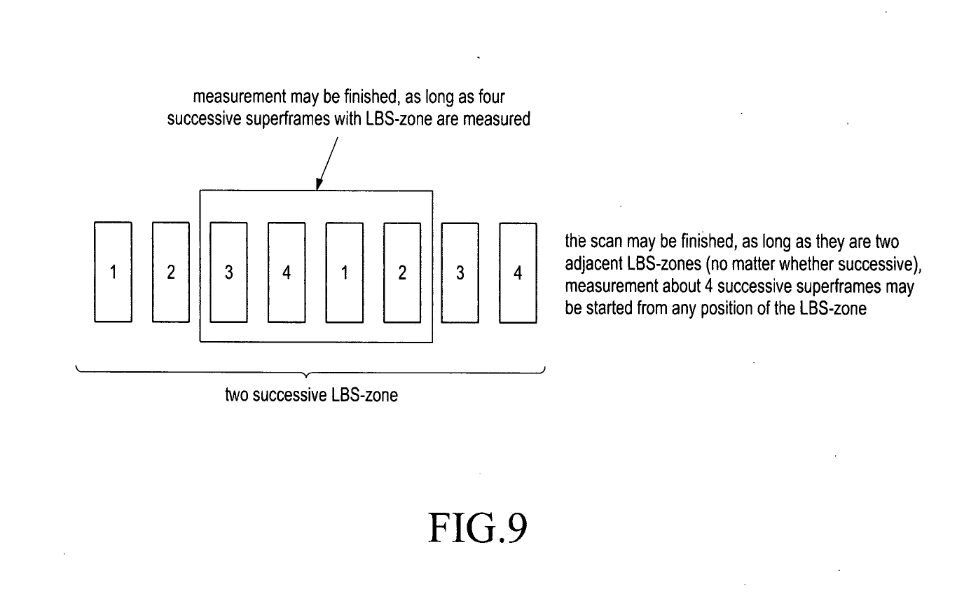

FIG. 9 is a schematic diagram illustrating a principle of sending with the mode shown in FIG. 6.

As shown in FIG. 9, when two successive LBS-zones exist, the MS may perform a scan last for four (4) successive superframes from any location of the LBS-zone. That is, the MS scans OFDM symbols of four (4) LBS-zones successively. In other words, the MS may scan with the sequence of 1234, or with the sequence of 3412, in which 1, 2, 3, 4 respectively denote the location of the OFDM symbol in the LBS-zone.

When the instruction message is located in SP2, the specific content thereof may refer to Table 6 below, which will be described in detail in the following.

When one bit is taken as the length of an instruction message, the one bit is configured to denote whether the current superframe and the next three (3) superframes include OFDM symbol of the LBS-zone. That is, the one bit is configured to denote whether the superframe where SP2 is located, and the next 3 superframes include OFDM symbol of the LBS-zone, and whether they may form a whole LBS-zone.

TABLE 6

| digit | |
|---|---|
| (bit) | description of instruction message |
| 1 | 0b0: denote current superframe and next 3 superframes not include |
| | OFDM code element of LBS-zone; |
| | 0b1: denote current superframe and next 3 |
| | superframes include OFDM code element of LBS-zone; |
| 2 | 0b00: denote current superframe n and next 3 superframes (n + 1, |
| | n + 2 and n + 3) not include OFDM code element of LBS-zone, |
| | and next four superframes (n + 4, n + 5, n + 6 and n + 7) |
| | subsequent to above 3 superframes also not include OFDM code |
| | element of LBS-zone; |
| | 0b01: denote current superframe n and next 3 superframes (n + 1, |
| | n + 2 and n + 3) not include OFDM code element of LBS-zone, |
| | and next four superframes (n + 4, n + 5, n + 6 and n + 7) |
| | subsequent to above 3 superframes include OFDM code element |
| | of LBS-zone; |
| | 0b10: denote current superframe n and next 3 superframes (n + 1, |
| | n + 2 and n + 3) include OFDM code element of LBS-zone, And |
| | next four superframes (n + 4, n + 5, n + 6 and n + 7) subsequent |
| | to above 3 superframes not include OFDM code element |
| | of LBS-zone; |
| | 0b11: denote current superframe n and next 3 superframes (n + 1, |
| | n + 2 and n + 3) include OFDM code element of LBS-zone, and |
| | next four superframes (n + 4, n + 5, n + 6 and n + 7) subsequent to |
| | above 3 superframes also include OFDM code element of |
| | LBS-zone. |

When two bits are taken as the length of an instruction message, the two bits are configured to denote whether the current superframe and next seven (7) superframes include OFDM symbol of the LBS-zone. The first bit denotes whether a superframe located by current SP2, and the next three (3) superframes include OFDM symbol of the LBS-zone. The second bit denotes whether a superframe located by next SP2, and the next three (3) superframes include OFDM symbol of the LBS-zone. And then the superframe located by current SP2, and the next three (3) superframes may form a whole LBS-zone. In the fourth embodiment, the MS demodulates SP2, so as to learn whether the superframe located by current SP2, and the next three (3) superframes include OFDM symbol of the LBS-zone. When the instruction message, which is demodulated by the MS from SP2, is 11, the MS may finish a complete LBS-zone scan by successively scanning four (4) superframes starting from any superframe of the superframe where current SP2 is located, and the next three (3) superframes. If the MS doesn't read SP2, the MS may learn the LBS-zone information until reading SP2. The scan delay may be three (3) superframes as a maximum.

When the instruction message is located in SP3, the specific content thereof may refer to Table 7 below, which will be described in detail in the following.

When one bit is taken as the length of an instruction message, the oen bit is configured to denote whether the current superframe and the next seven or fifteen superframes after the current superframes include OFDM symbol of the LBS-zone. Because of the long period of SP3, which may be 160 ms or 320 ms, four (4) successive LBS-zones may be included at most. Thus, the specific instruction meanings of the one bit may be as follows. Two (2) or four (4) successive LBS-zones exists between two SP3, or, one LBS-zone exists between two SP3, and location of the LBS-zone may be stipulated in advance. For example, it may be stipulated as the current frame of SP3 and the next 3 superframes, which may be determined by implementation of embodiments of the invention.

TABLE 7

| digit | |
|---|---|
| (bit) | description of instruction message |
| 1 | 0b0: denote current superframe and next 7 or 15 superframes |
| | not include OFDM code element of LBS-zone; |
| | 0b1: denote current superframe and next 7 or 15 superframes |
| | include OFDM code element of LBS-zone; (two kinds of |
| | meanings: the first one is that, all superframes emerged between |
| | two SP3 include OFDM code element of the LBS-zone; the other |
| | one is that, only one LBS-zone is emerged between two SP3) |
| 2 | 0b00: denote current superframe n, and next 7 superframes |
| | (n + 1 to n + 7) or next 15 superframes (n + 1 to n + 15) |
| | not include OFDM code of LBS-zone, and next 8 superframes |
| | (n + 8 to n + 15) or next 16 superframes (n + 16 to n + 31) |
| | subsequent to above element superframe also not include OFDM |
| | code element of LBS-zone; |
| | 0b01: denote current superframe n, and next 7 superframes |
| | (n + 1 to n + 7) or next 15 superframes (n + 1 to n + |
| | not include OFDM code element of LBS-zone, and next 8 |
| | 15) superframes (n + 8 to n + 15) or next 16 superframes (n + 16 |
| | to n + 31) subsequent to above superframe include OFDM |
| | code element of LBS-zone; |
| | 0b10: denote current superframe n, and next 7 superframes (n + 1 |
| | to n + 7) or next 15 superframes (n + 1 to n + 15) include OFDM |
| | code element of LBS-zone, and next 8 superframes (n + 8 to n + |
| | 15) next 16 superframes (n + 16 to n + 31) subsequent to above |
| | or superframe not include OFDM code element of LBS-zone; |
| | 0b11: denote current superframe n, and next 7 superframes (n + 1 |
| | to n + 7) or next 15 superframes (n + 1 to n + 15) include |
| | OFDM code element of LBS-zone, and next 8 superframes (n + 8 |
| | to n + 15) or next 16 superframes (n + 16 to n + 31) subsequent |
| | to above superframe also include OFDM code element of |
| | LBS-zone; |

When two bits are taken as the length of an instruction message, the two bits are configured to denote whether the current superframe and the next 15 or 31 superframes subsequent to the current superframe include OFDM symbol of LBS-zone. Because of the long interval between two SP3, there may be many kinds of specific meanings denoted by the two bits. The first kind is as follows. The first bit denotes whether a superframe located by current SP3 and the next three (3) superframes include OFDM symbol of the LBS-zone. The second bit denotes whether an LBS-zone exists between current SP3 and the next SP3. It denotes there is only one LBS-zone, when the bit indicates zero (0). It denotes that two (2) or four (4) successive LBS-zones will be emerged, that is, each superframe between two SP3 includes OFDM symbol of the LBS-zone, when the bit indicates one (1). The second kind is as follows. The first bit denotes whether an LBS-zone exists between current SP3 and next SP3. It denotes that one LBS-zone exists during the period (the start point may be stipulated or computed), and it also denotes that there are successive LBS-zones during the period, when the bit indicates one (1). The second bit denotes whether an LBS-zone exists between next SP3 and an SP3 subsequent to the next SP3 (the start point may be stipulated or computed), or the second bit may also denote there are successive LBS-zones during the period.

It should be noted that, after completing the judgment about whether an LBS-zone exists by adding an instruction message to a superframe header, the subsequent processing flow is similar to the first, second and third embodiments, and a detailed description will not be repeated here.

### A Fifth Embodiment

In the fifth embodiment, whether an LBS-zone exists may be determined by combining the following two modes. The first mode is to send a broadcast message to the MS by the serving BS. The second mode is to add an instruction message to a superframe header. The specific flow is as follows. Firstly, the LBS-zone information is carried in a broadcast signaling. If the MS fails to read the broadcast message or doesn't read the broadcast message, the MS determines whether an LBS-zone exists in the current superframe and subsequent superframe, according to the instruction message in the superframe header. Thus, measurement time delay of the MS may be reduced. And the MS may start measurement from any position of the LBS-zone.

The specific processing flow of the fifth embodiment may combine with the first and fourth embodiments, or combine with the second and fourth embodiments, or combine with the third and fourth embodiments, which will not be repeated here.

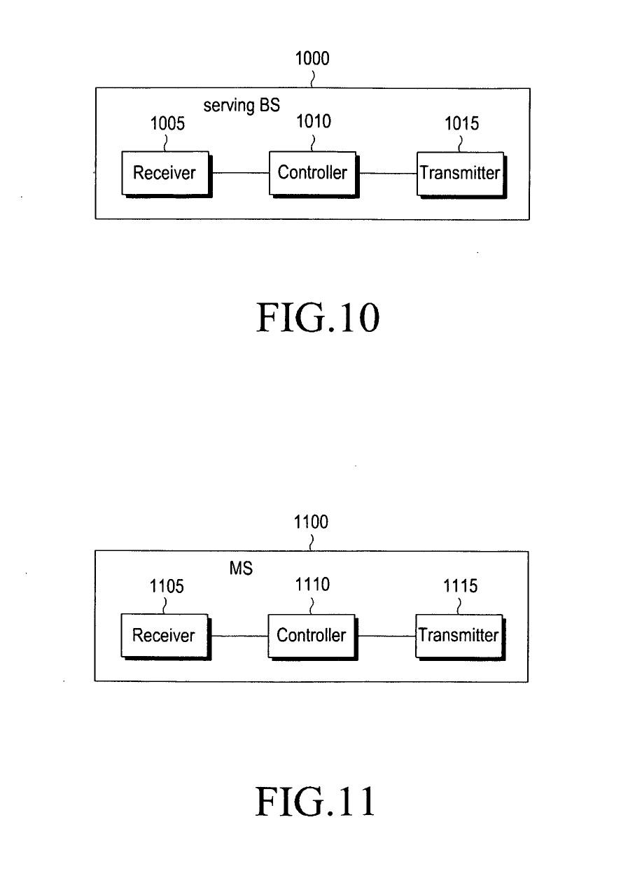

FIG. 10 is a block diagram illustrating a structure of a serving BS in accordance with embodiments of the invention.

Referring to FIG. 10, the serving BS 1000 includes a receiver 1005, controller 1010, and transmitter 1015.

The transmitter 1015 sends an instruction message indicating an LBS-zone providing LBS exists to a Mobile Station (MS). The controller 1010 controls the transmitter 1015 to send a broadcast message or a header of a superframe consisting the LBS-zone or the broadcast message including the header of the superframe, as the instruction message to the MS according to the embodiments of the invention. The information of the LBS-zone includes the period of the LBS-zone, or the period and duration of the LBS-zone, or the start point of the LBS-zone. Parameters included in the information of the LBS-zone are calculated by using the formulas, which will not be repeated here.

The receiver 1005 receives a measurement result for a reference signal sent by a neighbor BS located in the LBS-zone from the MS. The measurement results are measured by using information of the LBS-zone included in the instruction message.

FIG. 11 is a block diagram illustrating a structure of a MS in accordance with embodiments of the invention.

Referring to FIG. 11, the MS 1100 includes a receiver 1105, controller 1110, and transmitter 1115.

The receiver 1105 receives an instruction message indicating an LBS-zone providing LBS exists to the serving BS. The instruction message receives a broadcast message or a header of a superframe consisting the LBS-zone or the broadcast message including the header of the superframe, as the instruction message from the serving BS according to the embodiments of the invention.

The controller 1110 obtains information of the LBS-zone from the instruction message. The information of the LBS-zone includes period of the LBS-zone, or the period and duration of the LBS-zone, or the start point of the LBS-zone. Parameters included in the information of the LBS-zone are calculated by using the formulas, which will not be repeated here.

The receiver 1105 receives a reference signal from a neighbor BS located in the LBS-zone. The controller 1110 measures the reference signal, and then the transmitter 1115 transmits a measurement result to the serving BS.

In the application method of the LBS-zone adopted by embodiments of the invention, an instruction message indicating that an LBS-zone exists is sent to an MS, by a serving BS where the MS is located. When the LBS-zone exists, and the MS measures the reference signal sent by a neighbor BS in the LBS-zone, the MS receives a reference signal in the LBS-zone, which is sent by a neighbor BS and used for locating the MS, according to the information of the LBS-zone included in the instruction message. The MS may measure the reference signal, and send a measurement result to the serving BS, to enable the MS to accurately learn the information of the LBS-zone according to obtained instruction information, so as to implement normal measurement for the LBS-zone and measurement result feedback. That is, the LBS-zone may be enabled to be applied. Thus, the objective of implementing the LBS service for the MS by the serving BS with the LBS-zone may be achieved.

The foregoing describes example embodiments of the invention, which are not used for limiting the invention. Any modifications, equivalent substitutions and improvements made within the spirit and principle of the invention, should be covered by the protection scope of the invention.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for providing a location based service (LBS) by a serving base station (BS), comprising:
sending an instruction message indicating that an LBS-zone that provides LBS exists to a mobile station (MS); and
receiving a measurement result for a reference signal sent by a neighbor BS located in the LBS-zone from the MS,
wherein the measurement result is measured by using information of the LBS-zone included in the instruction message.

2. The method according to claim 1, wherein sending the instruction message to the MS comprises:
sending a broadcast message or a header of a superframe comprising the LBS-zone or the broadcast message including the header of the superframe, as the instruction message to the MS.

3. The method according to claim 2, further comprising:
if the broadcast message as the instruction message is sent to the MS, before sending the broadcast message, sending a scan response (SCN-RSP) signaling to the MS,
wherein the SCN-RSP signaling comprises triggering information to instruct scanning the reference signal to the MS, the triggering information representing a measurement duration of the LBS-zone.

4. The method according to claim 2, wherein an advanced air interface system configuration description (AAI_SCD signaling) as the broadcast message is sent to the MS.

5. The method according to claim 1, further comprising:
before receiving the measurement result, sending an auxiliary preamble to obtain a signal arrival time between the serving BS and the MS, to the MS,
wherein the auxiliary preamble comprises one of a plurality of preambles included in each frame of the superframe.

6. The method according to claim 1, wherein the information of the LBS-zone includes a period of the LBS-zone, or the period and duration of the LBS-zone, or a start point of the LBS-zone.

7. The method according to claim 6, wherein the start point of the LBS-zone represents a superframe number located by the start point of the LBS-zone, if the broadcast message having a format of a advanced air interface system configuration description (AAI_SCD signaling) as the instruction message is sent to the MS, the start point of the LBS-zone is obtained by using a superframe index located by an AAI-SCD signaling, a superframe number occupied by a whole LBS-zone, a large offset between the start point of the LBS-zone and the superframe index, and a remainder obtained by dividing the superframe index by the superframe number.

8. The method according to claim 2, wherein if the header of the superframe comprising the LBS-zone as the instruction message is sent to the MS, the information of the LBS-zone includes a period of the LBS-zone, or the period and duration of the LBS-zone, or a start point of the LBS-zone,
wherein a superframe number located by the start point of the LBS-zone is calculated by using (i) a superframe header sub-packet including parameters or configuration information of an initial LBS-zone or a superframe index located by the superframe header sub-packet, (ii) an emergence period of the LBS-zone, (iii) a remainder obtained by dividing the superframe index by the emergence period, and (iv) a bit length adopted by the superframe index.

9. A method for receiving a location based service (LBS) by a mobile station (MS), comprising:
receiving an instruction message indicating that an LBS-zone that provides LBS exists to a serving base station (BS);
obtaining information of the LBS-zone from the instruction message;
receiving a reference signal from a neighbor BS located in the LBS-zone; and
measuring the reference signal, and transmitting a measurement result to the serving BS.

10. The method according to claim 9, wherein receiving the instruction message comprises:
receiving a broadcast message or a header of a superframe comprising the LBS-zone or the broadcast message including the header of the superframe, as the instruction message from the serving BS.

11. The method according to claim 10, wherein an advanced air interface system configuration description (AAI_SCD signaling) as the broadcast message is received from the serving BS.

12. The method according to claim 9, wherein the information of the LBS-zone comprises a period of the LBS-zone, or the period and duration of the LBS-zone, or a start point of the LBS-zone.

13. A serving base station (BS) for providing a location based service (LBS), comprising:
a transmitter configured to send an instruction message indicating that an LBS-zone that provides LBS exists to a mobile station (MS); and
a receiver configured to receive a measurement result for a reference signal sent by a neighbor BS located in the LBS-zone from the MS,
wherein the measurement result is measured by using information of the LBS-zone included in the instruction message.

14. The serving BS according to claim 13, further comprising a controller configured to control the transmitter to send a broadcast message or a header of a superframe comprising the LBS-zone or the broadcast message including the header of the superframe, as the instruction message to the MS.

15. The serving BS according to claim 14, wherein if the broadcast message as the instruction message is send to the MS, before sending the broadcast message, the controller controls the transmitter to send a scan response (SCN-RSP) signaling to the MS,
wherein the SCN-RSP signaling includes triggering information to instruct scanning the reference signal to the MS, the triggering information representing a measurement duration of the LBS-zone.

16. The serving BS according to claim 14, wherein the controller controls that an advanced air interface system configuration description (AAI_SCD signaling) as the broadcast message is sent to the MS.

17. The serving BS according to claim 14, wherein before receiving the measurement result, the controller controls the transmitter to send an auxiliary preamble to obtain a signal arrival time between the serving BS and the MS, to the MS,
wherein the auxiliary preamble comprises one of a plurality of preambles included in each of frame of the superframe.

18. The serving BS according to claim 14, wherein the information of the LBS-zone includes a period of the LBS-zone, or the period and duration of the LBS-zone, or a start point of the LBS-zone.

19. The serving BS according to claim 18, wherein the start point of the LBS-zone represents a superframe number located by the start point of the LBS-zone, if the broadcast message having a format of a advanced air interface system configuration description (AAI_{_{—}}_{SCD} signaling) as the instruction message is sent to the MS, the start point of the LBS-zone is obtained by using a superframe index located by an AAI-SCD signaling, a superframe number occupied by a whole LBS-zone, a large offset between the start point of the LBS-zone and the superframe index, and a remainder obtained by dividing the superframe index by the superframe number.

20. The serving BS according to claim 15, wherein if the header of the superframe comprising the LBS-zone as the instruction message is sent to the MS, the information of the LBS-zone includes a period of the LBS-zone, or the period and duration of the LBS-zone, or a start point of the LBS-zone,
wherein a superframe number located by the start point of the LBS-zone is calculated by using (i) a superframe header sub-packet including parameters or configuration information of an initial LBS-zone or a superframe index located by the superframe header sub-packet, (ii) an emergence period of the LBS-zone, (iii) a remainder obtained by dividing the superframe index by the emergence period, and (iv) a bit length adopted by the superframe index.

21. A Mobile Station (MS) for receiving a location based service (LBS), the MS comprising:
a receiver configured to receive an instruction message indicating that an LBS-zone that provides LBS exists to a serving base station (BS), and receive a reference signal from a neighbor BS located in the LBS-zone;
a controller configured to obtain information of the LBS-zone from the instruction message, and measure the reference signal;
a transmitter configured to transmit a measurement result to the serving BS.

22. The MS according to claim 21, wherein the instruction message received comprises a broadcast message or a header of a superframe comprising the LBS-zone or the broadcast message including the header of the superframe.

23. The method according to claim 22, wherein an advanced air interface system configuration description (AAI_SCD signaling) as the broadcast message is received from the serving BS.

24. The method according to claim 21, wherein the information of the LBS-zone comprises a period of the LBS-zone, or the period and duration of the LBS-zone, or a start point of the LBS-zone.
